(19) United States
(12) Patent Application Publication
(10) Pub. No.: US 2023/0299384 A1
(43) Pub. Date: Sep. 21, 2023

(54) Composite Thermal Management Article and Thermal Management Assembly

(71) Applicant: 3M INNOVATIVE PROPERTIES COMPANY, St. Paul, MN (US)

(72) Inventors: Victor Ho, St. Paul, MN (US); Jacob P. Podkaminer, St. Paul, MN (US); Matthew T. Johnson, Woodbury, MN (US); Matthew H. Frey, Cottage Grove, MN (US); Samuel J. Carpenter, Maplewood, MN (US); Brandon A. Bartling, Woodbury, MN (US)

(21) Appl. No.: 18/020,529

(22) PCT Filed: Aug. 6, 2021
(86) PCT No.: PCT/IB2021/057275

§ 371 Date: Feb. 9, 2023

Related U.S. Application Data
(60) Provisional application No. 63/074,881, filed on Sep. 4, 2020.

(51) Int. Cl. H01M 10/6551; H01M 10/6555; H01M 10/658; H01M 50/124; H01M 50/143; H01M 50/202; H01M 50/289; H01M 50/293

(52) U.S. Cl. CPC H01M 10/6551; H01M 10/6555; H01M 10/658; H01M 50/124; H01M 50/143; H01M 50/202; H01M 50/289; H01M 50/293; H01M 10/653

(57) ABSTRACT

A thermal management assembly comprises an electrochemical cell, a heat sink, and a thermal pathway comprising a thermally interruptible interface interposed therebetween the electrochemical cell and the heat sink. The thermal pathway comprises an expandable material comprising intumescent particles. If heated to at least a first onset temperature, the expandable material expands and causes at least partial shear delamination at the first thermally interruptible interface. A composite thermal management article comprises a first layer comprising an expandable material comprising intumescent particles and a second layer comprising a thermal conductor material. The first and second layers contact each other at a thermally interruptible interface. If heated to at least a first onset temperature, the expandable material expands and causes at least partial shear delamination at the thermally interruptible

### TECHNICAL FIELD

The present disclosure broadly relates to thermal management of batteries.

### BACKGROUND

Battery lifetime and reliability are critical metrics for next-generation electric vehicles. These measures are a function of the thermal history experienced by each electrochemical cell in the battery during operation because elevated temperatures can cause undesired irreversible electrochemical reactions that decrease its capacity. Therefore, ideally each cell in the battery would experience identical thermal histories and thereby age to the same degree. To achieve this, batteries should be in constant thermal contact during normal operation to increase the effective thermal mass of each cell. This can spread any transient thermal spikes of an individual cell over the entire battery module or pack.

However, in the situation where the thermal energy released from the electrochemical reaction surpasses the heat removal rate, termed a runaway event, autoacceleration of the reaction can lead to catastrophic failure, termed a runaway event. If this occurs, and all cells of a module are in thermal communication, then a single cell can initiate runaway for neighboring cells and failure or even combustion of the entire pack is accelerated. The cascade of thermal runaway from one cell to a neighboring cell is called thermal runaway propagation, and its delay or avoidance is desired. Thus, there can be a need at times for neighboring cells to be thermally isolated from each other.

### SUMMARY

To address these apparently contradictory needs, there is a need for materials and products that provide a low thermal resistance between cells during normal operating temperatures (i.e., <60° C.) but abruptly increase in thermal resistance at an elevated temperature (ideally between 80° C. and 200° C.).

The present disclosure addresses this need by providing a composite material that comprises an expandable component which expands its volume significantly once an onset temperature is reached that corresponds to adverse battery conditions.

However, mere expansion that is accompanied by a substantial volumetric increase, which may be on the order of several hundred percent, can either apply stress on the walls of battery cells/modules or may generate high pressure if the system is closed. In extreme cases the construction may be constrained to the point of preventing sufficient volume expansion and thereby precluding the primary mechanism for decreasing the thermal conductivity.

The present disclosure provides a technical solution that (a) provides a thermal pathway for heat during normal operation, (b) introduces a large thermal resistance upon onset, and (c) accomplishes this change without large dimensional changes being required.

In one aspect, the present disclosure provides a thermal management assembly comprising:
a first electrochemical cell;
a heat sink; and
a thermal pathway comprising a thermally interruptible interface interposed between the first electrochemical cell and the heat sink,
wherein the thermal pathway has a thermal conductance between the first electrochemical cell and the heat sink,
wherein the thermal pathway comprises an expandable material comprising intumescent particles, wherein the expandable material intimately contacts the thermally interruptible interface, and wherein, if heated to at least a first onset temperature, the expandable material expands and causes at least partial shear delamination at the thermally interruptible interface, thereby reducing the thermal conductance of the thermal pathway.

In some embodiments, the thermal pathway further comprises a thermal conductor material in intimate contact with the expandable material at the thermally interruptible interface.

In another aspect, the present disclosure provides a composite thermal management article comprising:
a first layer comprising intumescent particles;
a second layer, wherein the first and second layers intimately contact each other at a thermally interruptible interface, and wherein, if heated to at least a first onset temperature, the first layer expands to and causes at least partial shear delamination from the second layer at the thermally interruptible interface.

Unless otherwise noted, as used herein:
the term “battery” refers to an assembly of two or more electrochemical cells arranged in series and having positive and negative electrodes; and
the term “thermally conductive” means having a thermal conductivity of at least 0.5 watt per meter-kelvin (i.e., W/mK or equivalently W·m⁻¹K⁻¹) at 50° C.

Features and advantages of the present disclosure will be further understood upon consideration of the detailed description as well as the appended claims.

### BRIEF DESCRIPTION OF THE DRAWINGS

FIG. 1 is a schematic side view of an exemplary composite thermal management article 28 according to the preset disclosure.

FIG. 2 is a schematic process flow diagram showing thermally induced shear delamination of composite thermal management article 28.

FIG. 3 is a schematic side view of an exemplary of an exemplary thermal management assembly 300 according to the present disclosure.

FIG. 4 is a schematic side view of an exemplary of an exemplary thermal management assembly 400 according to the present disclosure.

FIG. 5 is a schematic side view of an exemplary of an exemplary thermal management assembly 500 according to the present disclosure.

FIG. 6 is a schematic side view of an exemplary of an exemplary thermal management assembly 600 according to the present disclosure.

FIG. 7 is a schematic side view of an exemplary of an exemplary thermal management assembly 700 according to the present disclosure.

FIG. 8 is a schematic side view of an exemplary of an exemplary thermal management assembly 800 according to the present disclosure.

FIG. 9 is a schematic side view of an exemplary of an exemplary thermal management assembly 900 according to the present disclosure.

FIG. 10 is a schematic side view of an exemplary of an exemplary thermal management assembly 1000 according to the present disclosure.

FIG. 11 is a schematic side view of an exemplary composite thermal management article 1100 according to the present disclosure.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

The thermal management assembly and the composite thermal management article of the present disclosure operate on the principle of shear delamination between two different materials along a thermally interruptible interface. Shear delamination occurs when heating to at least an onset temperature causes intumescent particles in one layer to expand. This expansion causes shear strain at the interface and results in delamination and formation of at least one gap at the thermally interruptible interface that reduces thermal conductance across the thermally interruptible interface, and hence also the thermal pathway. Advantageously, shear delamination can occur even when the expandable material is present as a thin layer, which makes the present disclosure practical for application where space is limited.

Thermal management assemblies according to the present disclosure include an electrochemical cell and a heat sink. In some preferred embodiment the heat sink is also an electrochemical cell. In this case, thermal runaway of one of the electrochemical cells in a battery triggers delamination and mitigates heating of the adjacent electrochemical cell.

While any type of electrochemical cell may be used (e.g., galvanic cells, voltaic cells, electrolytic cells, and fuel cells), the present disclosure may have particular applicability to rechargeable electrochemical cells. Exemplary rechargeable electrochemical cells include nickel-cadmium (NiCd), nickel—metal hydride (NiMH), lithium-ion (Li-ion), lithium iron phosphate (LiFePO₄), and lithium-ion polymer (Li-ion polymer) cells. Of these, lithium-containing rechargeable electrochemical cells and batteries containing them are known to experience occasional thermal runaway events due to, for example, internal short circuiting, overcharging and/or physical damage. To reduce these events and for convenience batteries (except for the terminal electrodes) are often enclosed and sealed within a casing. Electrochemical cells of any format may be used, including but not limited to cylindrical cells, prismatic cells, and pouch cells.

A heat sink is a device or substance for absorbing excessive or unwanted heat from a heat source. Typically, a heat sink is a passive heat exchanger that transfers the heat generated by an electronic or a mechanical device to a fluid medium, often air or a liquid coolant, where it is dissipated away from the device, thereby allowing regulation of the device's temperature; however, this is not a requirement. In electronic devices a heat sink is usually designed to maximize its surface area in contact with the cooling medium surrounding it, such as the air. In the context of thermal management assemblies of the present disclosure, a heat sink may be a neighboring cell to a thermal runaway cell that is heating (e.g., self-heating) to a higher temperature than the neighboring cell.

Air velocity, choice of material, protrusion design and surface treatment are factors that affect the performance of a heat sink. Thermal adhesive or thermal grease improve the heat sink's performance by filling air gaps between the heat sink and a heat spreader (e.g., fins) on a device. A heat sink is often made out of aluminum or copper, although other materials may also be used.

The expandable material may comprise a composite of an organic polymer and intumescent particles. Exemplary organic polymers include acrylic polymers (e.g., polymethyl methacrylate, polyethyl acrylate, polyacrylonitrile), polyolefins (e.g., polyethylene, high molecular weight (HMW) polyethylene ultra high molecular weight (UHMW) polyethylene polypropylene, polybutadiene, ethylene-propylene copolymers, and ethylene-propylene diene rubbers (EPDM)), styrenic polymers (e.g., polystyrene, acrylonitrile butadiene styrene (ABS), polyvinyl ethers, silicones, polyurethanes, polyethers, polyamines, polyamides, polyesters, polycarbonates, liquid crystalline polymers, and combinations thereof. Such materials are widely available for commercial sources. The organic polymer may be linear, chemically crosslinked. or it may comprise a mixture of both types of organic polymers.

The organic polymer may be melt-processed (e.g., by extrusion), solvent borne, and/or at least partially cured curable resins. If the average number of polymerizable groups per polymerizable compound is greater than one, then chemically crosslinked polymers can be achieved through curing. Suitable curable resins may include, for example, epoxy resins, urethane resins, ring-opening metathesis polymerization (ROMP) cycloolefin resins, isocyanurate resins, free-radically polymerizable resins (e.g., mono- and/or polyfunctional acrylates, methacrylates, acrylamides, vinyl ethers, and/or maleates), phenolic resins, urea-formaldehyde resins, aminoplast resins, silicone resins, and self-crosslinking polymer latexes. In some cases, a curative such as, for example, a free-radical initiator (thermal initiator or photoinitiator), amine crosslinker, and/or acid catalyst is typically used in combination with the curable resin. The selection of a curative and relative amounts to be used, as well as curing conditions, are within the capabilities of those of ordinary skill in the art.

Intumescent particles useful in practice of the present disclosure are typically particulate materials that irreversibly expand to many times their original size if heated to an onset temperature (i.e., Tonset). Examples of intumescent particles include heat expandable polymeric microspheres (e.g., as available under the trade designations EXPANCEL DU from Nouryon, Amsterdam, The Netherlands, and DUALITE U from Chase Corp., Westwood Massachusetts), perlite, unexpanded vermiculite, intumescent graphite, ammonium polyphosphate, sodium silicates, hydrobiotite, and water swellable synthetic tetrasilicic fluorine-type mica described in U.S. Pat. No. 3,001,571 (Hatch), and combinations thereof. Of these, expandable polymer microspheres are typically preferred if a relatively low onset temperature is desired.

Commercially available grades of DUALITE expandable polymer microspheres include U020-125W (Tₒₙₛₑₜ=85-90° C.); U018-130W (Tₒₙₛₑₜ=90-95° C.); U015-135D (Tₒₙₛₑₜ=95-100° C.); U024-145W (Tₒₙₛₑₜ=115-120° C.); U005-190W (Tₒₙₛₑₜ=130-135° C.); U017-175W (Tₒₙₛₑₜ=140-145° C.); and U010-185W (Tₒₙₛₑₜ=145-150° C.). Commercially available grades of EXPANCEL DU expandable polymer microspheres include FG52 DU 80 (Tₒₙₛₑₜ=94-105° C.); FG92 DU 120 (Tₒₙₛₑₜ=122-132° C.); 642 WU 40 (Tₒₙₛₑₜ=87-93° C.); 551 WU 40 (Tₒₙₛₑₜ=94-99° C.); 461 WU 20 (Tₒₙₛₑₜ=100-106° C.); and 909 WU 80 (Tₒₙₛₑₜ=120-130° C.).

The intumescent particles may have any desired particle size. In some embodiments, the intumescent particles have a volume average particle diameter in the range of 0.01 to 500 microns, preferably 0.1 to 150 microns. The amount of intumescent particles is typically at least 10 volume percent, at least 20 volume percent, at least 30 volume percent, at least 40 volume percent, or even at least 50 volume percent of the first and more preferably greater than 50 volume percent based on the total volume of the expandable material.

The expandable material may have a lower thermal conductivity than the thermal conductor material(s), if present in the thermal pathway, although this is not a requirement. In such embodiments, the expandable material may have a thermal conductivity of 0.9, 0.75, 0.5, or even 0.05 times that of the thermal conductor material(s).

In some embodiments, a thermal conductor material is present. The thermal conductor material and/or the expandable material may have a thermal conductivity of at least 0.5 watt per meter-kelvin (i.e., W/mK or equivalently W·m⁻¹K⁻¹) at 50° C., more preferably at least 1 Wm⁻¹K⁻¹, at least 2.5 Wm⁻¹K⁻¹, at least 5 Wm⁻¹K⁻¹, at least 10 Wm⁻¹K⁻¹, at least 15 Wm⁻¹K⁻¹, at least 20 W˜m⁻¹K⁻¹, or even at least at least 30 Wm⁻¹K⁻¹; however, this is not a requirement, especially if present as a thin layer.

The thermal conductor material may comprise an organic polymer binder, for example, as described with respect to the expandable material.

In some embodiments, the expandable material and/or the thermal conductor material further comprises thermally conductive filler particles (i.e., thermal filler). Any thermal filler may be used including, for example, particles comprising at least one of aluminum oxide (alumina), magnesium oxide, aluminum hydroxide, silicon nitride, zinc oxide, silicon oxide, beryllium oxide, titanium oxide, copper oxide, cuprous oxide, boron nitride, aluminum nitride, silicon carbide, diamond, talc, mica, kaolin, bentonite, magnesite, pyrophyllite, titanium boride, calcium titanate, metal (e.g., copper, aluminum, brass, steel, bronze), graphite, carbon black, graphene, and combinations thereof.

Thermal filler may have any desired particle size. In some embodiments, the thermal filler has a volume average particle diameter in the range of 0.01 to 500 microns, preferably 0.1 to 150 microns. If present, the amount of thermal filler is typically greater than 30 volume percent, preferably greater than 40 volume percent, and more preferably greater than 50 volume percent based on the total volume of the first thermal material.

Thermal fillers can be readily obtained from commercial vendors, and optionally processed (e.g., milled and/or classified) to provide a desired average particle size.

The expandable material and/or thermal conductor material may further comprise additives such as for example, antioxidants, UV stabilizers, fillers, plasticizers, colorants, flame retardants, and fragrances, if desired.

In some preferred embodiments, the expandable material and/or the thermal conductor material comprises (e.g., has the form of) a thin layer. These embodiments are advantageous, because in-plane expansion (i.e., causing shear force) remains constant but thickness expansion is minimized allowing use in confined spaces.

Preferably, the thermal conductance between the first electrochemical cell and the heat sink is reduced by at least 50 percent, at least 75 percent, or even at least 90 percent at a temperatures at or above the first onset temperature.

In embodiments with expandable material and thermal conductor material layers, the total combined volume of the layers preferably increases less than 50 percent, less than 25 percent, or even less than 10 percent at or above the first onset temperature, although this is not a requirement.

In embodiments having multiple expandable material layers that each contain respective intumescent particles, it is contemplated that the respective intumescent particles in each expandable material layer may have the same or different onset temperatures.

Shear delamination that occurs at the thermally interruptible interface due to expansion of the intumescent particles results in debonding of the expanded expandable material from whatever element (e.g., thermal conductor material, heat sink, or electrochemical cell) that it is bonded to, and which forms the thermally interruptible interface. Commonly, such shear delamination is readily visually detectable by an unaided human eye with 20/20 vision, but may be enhanced by microscopic inspection.

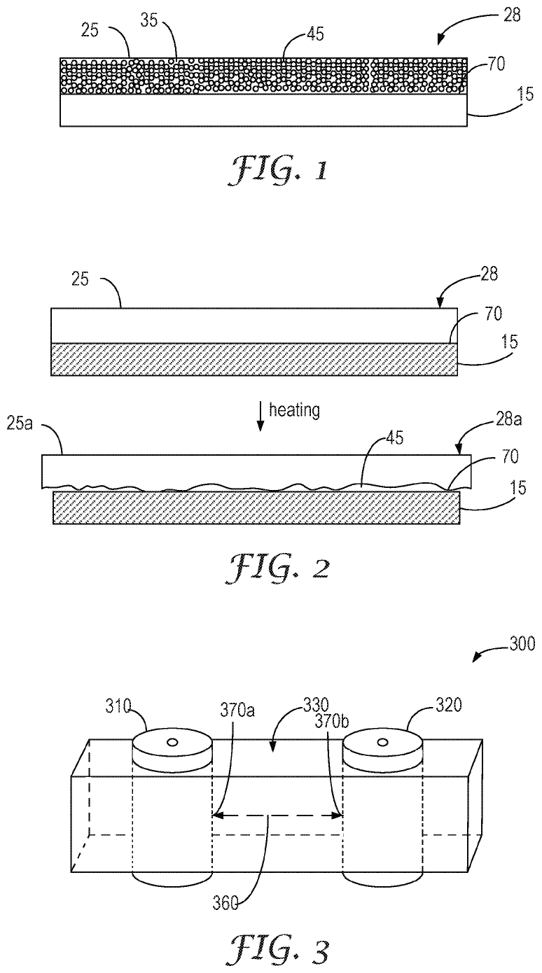

FIGS. 1 and 2 are instructive for explaining the mode of operation of the composite thermal management article (and the thermal management assembly) of the present disclosure. Referring now to FIG. 1, a composite thermal management article 28 comprises an expandable material 25. Expandable material 25 comprises intumescent particles 45 retained in an organic polymer binder 35. Thermal conductor material 15 contacts expandable material 25 at thermally interruptible interface 70. Upon heating, the intumescent particles in the expandable material 25 expand (optionally with decomposition and/or rupture).

Referring now to FIG. 2, composite thermal management article 28 is transformed into composite thermal management article 28a by heating to at least the onset temperature of the intumescent particles, whereupon the intumescent particles expand (optionally with decomposition and/or rupture) creating shear stress along the thermally interruptible interface 70, and ultimately causing shear delamination and formation of gaps 45. By this process, heat flow from the expandable material to the thermal conductor material across the thermally interruptible interface is reduced. Various embodiments of a thermal management assembly and composite thermal management article that exploit this discovery will now be discussed.

Referring now to FIG. 3, thermal management assembly 300 comprises electrochemical cell 310, heat sink 320 (shown also as an electrochemical cell). Expandable material 330, comprising intumescent particles retained in an organic polymer binder (both not shown), contacts and conforms to the surfaces of both the electrochemical cell and the heat sink. Thermal pathway 360 extends between the

electrochemical cell and the heat sink through thermally interruptible interfaces 370a and 370b.

It will be recognized that thermally interruptible interface 370b is primarily useful when the heat sink can be damaged by excess heat build up, otherwise it is generally desirable that the interface between expandable material 330 and heat sink 320 be thermally conductive and not interruptible.

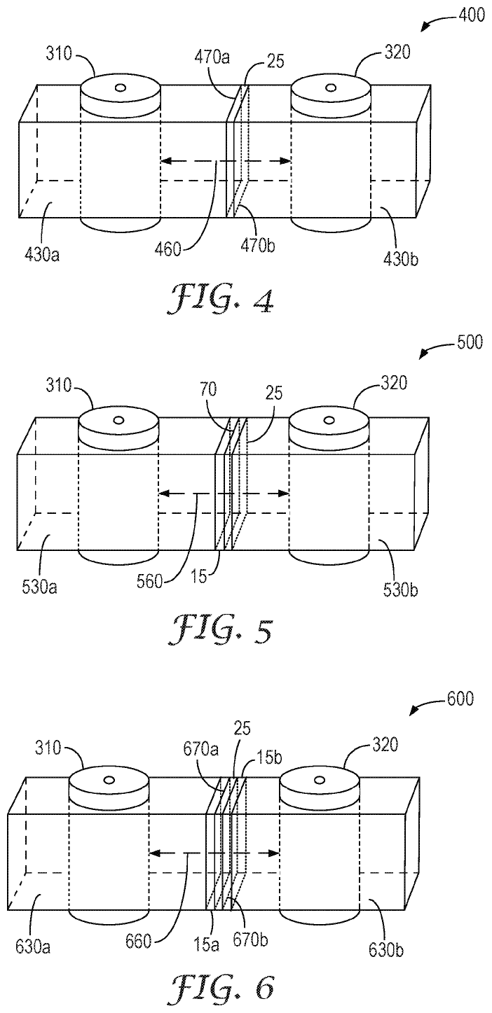

FIG. 4 shows a similar thermal management assembly 400. Thermal management assembly 400 comprises electrochemical cell 310, heat sink 320, and thermal conductor materials 430a, 430b, which may be the same or different. Expandable material 25 (see FIG. 1) is disposed as a layer separating thermal conductor materials 430a, 430b. Thermal pathway 460 extends between electrochemical cell 310 and heat sink 320 and passes through thermally interruptible interfaces 470a, 470b.

FIG. 5 shows yet another similar thermal management assembly 500. Thermal management assembly 500 comprises electrochemical cell 310; heat sink 320; and first, second, and third thermal conductor materials 15, 530a, 530b, which may be the same or different. Expandable material 25 (see FIG. 1) is interposed between first and third thermal conductor materials 530a, 530b. Thermal pathway 560 extends between electrochemical cell 310 and heat sink 320 and passes through thermally interruptible interface 70.

FIG. 6 shows yet another similar thermal management assembly 600. Thermal management assembly 600 comprises electrochemical cell 310; heat sink 320; and first, second, third, and fourth thermal conductor materials 15a, 15b, 630a, 630b, which may be the same or different. Expandable material 25 is interposed between first and second thermal conductor materials 15a, 15b (identical to 15 in FIG. 1), which in turn are interposed between third and fourth thermally conductor materials 630a, 630b. Thermal pathway 660 extends between electrochemical cell 310 and heat sink 320 and passes through thermally interruptible interfaces 670a, 670b.

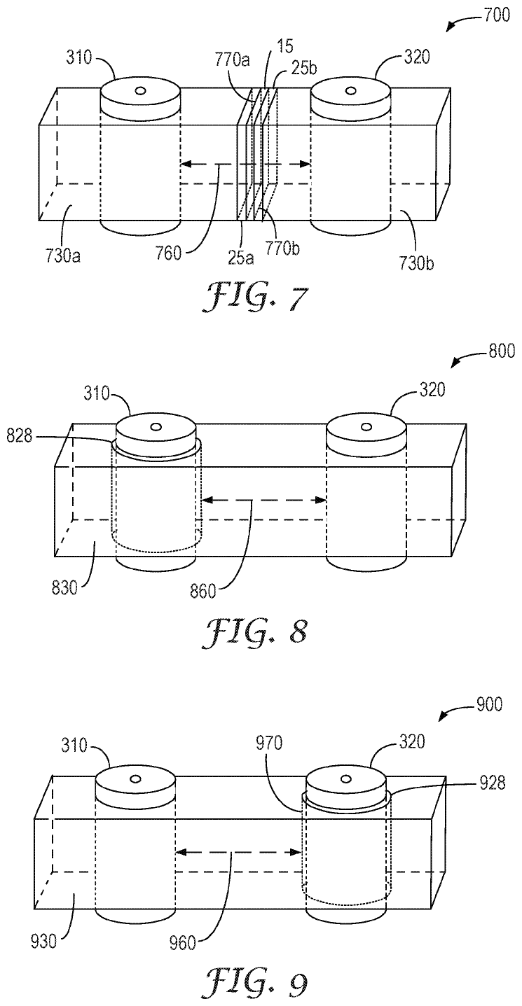

FIG. 7 shows yet another similar thermal management assembly 700. Thermal management assembly 700 comprises electrochemical cell 310; heat sink 320; and first, second, and third thermal conductor materials 15, 730a, 730b, which may be the same or different. Thermal conductor material 15 is interposed between first and second expandable materials 25a, 25b (identical to 25 in FIG. 1), which in turn are interposed between second and third thermally conductor materials 730a, 730b. Thermal pathway 760 extends between electrochemical cell 310 and heat sink 320 and passes through thermally interruptible interfaces 770a, 770b.

FIG. 8 shows yet another similar thermal management assembly 800. Thermal management assembly 800 comprises electrochemical cell 310, heat sink 320, thermal conductor material 830, and composite thermal management article 828, which is identical to 28 (see FIG. 1) wound around electrochemical cell 310. It may be in either of two configurations; that is, the expandable material 25 (see FIG. 1) can be facing outward or inward. Thermally interruptible interface 70 is disposed between the expandable and thermal conductor materials 25, 15 (see FIG. 1). Thermal pathway 860 extends between electrochemical cell 310 and heat sink 320 and passes through thermally interruptible interface 70.

In another embodiment, not shown, an expandable material layer may be substituted for the composite thermal management article 828 in FIG. 8.

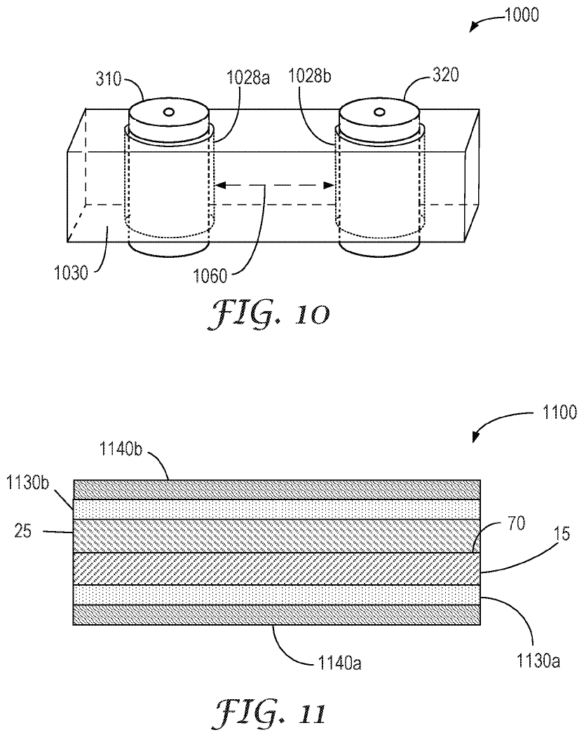

FIG. 9 shows yet another similar thermal management assembly 900. Thermal management assembly 900 comprises electrochemical cell 310, heat sink 320, and composite thermal management article 928, which is identical to 28 (see FIG. 1) wound around heat sink 320. It may be in either of two configurations; that is, the expandable material 25 (see FIG. 1) can be facing outward or inward. Thermally interruptible interface 70 is disposed between the expandable and thermal conductor materials 25, 15 (see FIG. 1). Thermal pathway 960 extends between electrochemical cell 310 and heat sink 320 and passes through thermally interruptible interface 70.

In another embodiment, not shown, an expandable material layer may be substituted for the composite thermal management article 928 in FIG. 9.

FIG. 10 shows yet another similar thermal management assembly 1000. Thermal management assembly 1000 comprises electrochemical cell 310, heat sink 320, and composite thermal management articles 1028a, 1028b, which are identical to 28 (see FIG. 1) wound around electrochemical cell 310 and heat sink 320, respectively. Composite thermal management articles 1028a, 1028b may independently be in either of two configurations; that is, the expandable material 25 (see FIG. 1) can be facing outward or inward. Thermally interruptible interface 70 is disposed between the expandable and thermal conductor materials 25, 15 (see FIG. 1). Thermal pathway 960 extends between electrochemical cell 310 and heat sink 320 and passes through thermally interruptible interface 70.

In another embodiment, not shown, an expandable material layer may be substituted for the composite thermal management article 928 in FIG. 10.

Other embodiments of composite thermal management article 28 are shown in FIG. 11. Referring now to FIG. 11, composite thermal management article 1100 comprises layer of expandable material 25. Expandable material 25 comprises intumescent particles 45 retained in an organic polymer binder 35 (see FIG. 1). Optional layer of thermal conductor material 15 contacts the layer of expandable material 25 at thermally interruptible interface 70. First adhesive layer 1130a, which may be, for example, a hot melt and/or pressure-sensitive adhesive layer, is disposed on layer of thermal conductor material 15 opposite the layer of expandable material 25. Optional first release liner 1140a is releasably adhered to adhesive layer 1130a. Optional second adhesive layer 1130b, which may be, for example, a hot melt and/or pressure-sensitive adhesive layer independent from first adhesive layer 1130a, is disposed on layer of expandable material 25 opposite layer of thermal conductor material 15. Optional second release liner 1140b is releasably adhered to adhesive layer 1130b.

Upon heating, the intumescent particles in the layer of expandable material 25 expand (optionally with decomposition and/or rupture).

Pressure-sensitive adhesives (e.g., acrylic pressure-sensitive adhesives, and hot melt adhesives (e.g., styrene-block-butadiene-block-styrene (SBS) copolymer hot melt adhesives) are widely available from commercial sources, and selection of them is within the capability of those of ordinary skill in the art. The composite thermal management article may be provided in any form; for example, a sheet, a stack of sheets, or a roll.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight.

### Materials

| DESIGNATION | DESCRIPTION | SOURCE |
|---|---|---|
| EHA | Ethylhexyl acrylate | obtained from BASF, |
| | | Florham Park, New |
| | | Jersey |
| HDDA | Hexanediol diacrylate | obtained as SR 238 from |
| | | Sartomer, Exton, |
| | | Pennsylvania |
| IRG 651 | 2,2-Dimethoxy-1,2-diphenylethan-1-one | obtained as IRGACURE |
| | photoinitiator | 651 from BASF |
| IRG 819 | Bis(2,4,6-trimethylbenzoyl)phenylphosphine | obtained as IRGACURE |
| | oxide photoinitiator | 819 from BASF |
| BAK70 | Spherical alumina, D₅₀~70 micron | obtained from Bestry, |
| | | Shanghai, China |
| BAK10 | Spherical alumina, D₅₀~10 micron | obtained from Bestry |
| TM1250 | Semi-spherical alumina, D₅₀~1.2 micron | obtained from Huber, |
| | | Atlanta, Georgia |
| U018-130D | Expandable microspheres, Tₒₙₛₑₜ = 90-95° C. | obtained as DUALITE |
| | | U018-130D from Chase |
| | | Corporation, Westwood, |
| | | Massachusetts |
| RF32N | PET coated release liner | obtained from SKC Haas, |
| | | Shenzhen City, China |

### Base Syrup

Base syrup was prepared by combining 350 g of EHA and 0.14 g of IRG 651 in a one-quart glass jar and mixed using a high shear electric motor until a homogeneous mixture was obtained. The resultant mixture was degassed for five minutes by bubbling nitrogen through a tube inserted in an opening of the lid. While stirring, the mixture was exposed to UVA light until a pre-adhesive syrup having a viscosity deemed suitable for coating was formed. Following UV exposure, air was introduced into the jar. This prepolymer was then mixed with 0.22 part per hundred (phr) of HDDA and 0.43 phr of IRG 819 to form the final base syrup formulation.

### Non-Expandable Layer

The coating solution was prepared by mixing 12.6 parts by weight of the Base Syrup, 52.4 parts by weight BAK70, 17.5 parts by weight BAK10, and 17.5 parts by weight TM1250 under high shear and partial vacuum (10 mbar). The solution was then coated between two RF32N liners using a notched bar coater at a nominal gap of 500 microns. The coating was cured by exposing the PET surface to UVA energy.

### Expandable Layer A

A coating solution was prepared by mixing 95.2 parts by weight of the Base Syrup and 4.8 parts by weight U018-130D under high shear and partial vacuum (10 mbar). The solution was then coated between two RF32N liners using a notched bar coater at a nominal gap of 100 microns. The coating was cured by exposing the PET surface to UVA energy.

### Expandable Layer B

A coating solution was prepared by mixing 90.9 parts by weight Base syrup and 9.1 parts by weight U018-130D under high shear and partial vacuum (10 mbar). The solution was then coated between two RF32N liners using a notched bar coater at a nominal gap of 100 microns. The coating was 15 cured by exposing the PET surface to UVA energy.

### Expandable Layer C

The coating solution was prepared by mixing 87.0 parts by weight of Base Syrup and 13.0 parts by weight U018-130D under high shear and partial vacuum (10 mbar). The solution was then coated between two RF32N liners using a notched bar coater at a nominal gap of 100 microns. The coating was cured by exposing the PET surface to UVA energy.

### Expandable Layer D

The coating solution was prepared by mixing 83.3 parts by weight of Base Syrup and 16.7 parts by weight of U018-130D under high shear and partial vacuum (10 mbar). The solution was then coated between two RF32N liners using a notched bar coater at a nominal gap of 100 microns. The coating was cured by exposing the PET surface to UVA energy.

### Expandable Layer E

The coating solution was prepared by mixing 80.0 parts by weight of Base syrup and 20.0 parts by weight U018-130D under high shear and partial vacuum (10 mbar). The solution was then coated between two RF32N liners using a notched bar coater at a nominal gap of 100 microns. The coating was cured by exposing the PET surface to UVA energy.

### Example 1 (EX-1)

An approximately 2 in×2 in (5.1 cm×5.1 cm) square was cut from the cured Expandable Layer A and two 2 in×2 in (5.1 cm×5.1 cm) squares were cut from the cured Thermally Conductive Layer A. After removing the PET liner from one face of the Expandable Layer A and one of the Thermally Conductive Layer A squares, the squares were then laminated together using a hand-held roller to remove air. The PET liner was then removed from the exposed face of the Expandable Layer and from one face of the remaining Thermally Conductive Layer A squares. The Thermally Conductive Layer A was then laminated to the exposed face of the Expandable Layer using a hand-held roller to obtain the final multilayer construction.

### Example 2 (EX-2)

EX-2 was constructed following the same procedure as EX-1, except using Expandable Layer B in place of Expandable Layer A.

### Example 3 (EX-3)

EX-3 was constructed following the same procedure as EX-1, except using Expandable Layer C in place of Expandable Layer A.

### Example 4 (EX-4)

EX-4 was constructed following the same procedure as EX-1, except using Expandable Layer D in place of Expandable Layer A.

### Example 5 (EX-5)

EX-5 was constructed following the same procedure as EX-1, except using Expandable Layer E in place of Expandable Layer A.

### Comparative Example 1 (CE-1)

CE-1 was constructed as a single expandable layer. The coating solution was prepared by mixing 6.25 g of Base Syrup, 20.25 g of BAK70, 6.75 g of BAK10, 6.75 g of TM1250, and 0.064 g of U018-130D under high shear and partial vacuum (10 mbar). The solution was then coated between two RF32N liners using a notched bar coater at a nominal gap of 500 microns. The coating was cured by exposing the PET surface to UVA.

### Comparative Example 2 (CE-2)

CE-2 was constructed as a single expandable layer. The coating solution was prepared by mixing 6.25 g of Base Syrup, 20.25 g of BAK70, 6.75 g of BAK10, 6.75 g of TM1250, 0.122 g of U018-130D under high shear and partial vacuum (10 mbar). The solution was then coated between two RF32N liners using a notched bar coater at a nominal gap of 500 microns. The coating was cured by exposing the PET surface to UVA.

### Comparative Example 3 (CE-3)

CE-3 was constructed as a single expandable layer. The coating solution was prepared by mixing 6.25 g Base Syrup, 20.25 g of BAK70, 6.75 g of BAK10, 6.75 g of TM1250, and 0.176 g of U018-130D under high shear and partial vacuum (10 mbar). The solution was then coated between two RF32N liners using a notched bar coater at a nominal gap of 500 microns. The coating was cured by exposing the PET surface to UVA.

### Comparative Example 4 (CE-4)

CE-4 was constructed as a single expandable layer. The coating solution was prepared by mixing 6.25 g of Base syrup, 20.25 g of BAK70, 6.75 g of BAK10, 6.75 g of TM1250, and 0.224 g of U018-130D under high shear and partial vacuum (10 mbar). The solution was then coated between two RF32N liners using a notched bar coater at a nominal gap of 500 microns. The coating was cured by exposing the PET surface to UVA energy.

### Comparative Example 5 (CE-5)

CE-4 was constructed as a single expandable layer. The coating solution was prepared by mixing 6.25 g of Base Syrup, 20.25 g of BAK70, 6.75 g of BAK10, 6.75 g of TM1250, and 0.269 g of U018-130D under high shear and partial vacuum (10 mbar). The solution was then coated between two RF32N liners using a notched bar coater at a nominal gap of 500 microns. The coating was cured by exposing the PET surface to UVA energy.

### Test Methods

### Measurement of Apparent Thermal Conductivity

The effective thermal conductivity was determined according to the following procedure. Circular discs of 33 mm in diameter were punched from a layer or multilayer construction either before or after thermal expansion. After the releasable liner was removed from both faces of the punched sample, the disc was placed on the bottom plate of the TIM Tester (Analysis Tech, Wakefield, Massachusetts) and the top plate was slowly lowered into contact with the top surface of the sample and the minimum allowable pressure (<10 psi) was applied. The top plate was heated and bottom plate cooled until a temperature gradient was established with an average sample temperature of 50° C. The apparent thermal conductivity was calculated by dividing the sample thickness by the thermal impedance. The reported value includes the contact resistance from the interface between each plate and the sample surfaces.

### Expansion

Circular discs of 33 mm in diameter were punched from the multilayer constructions. Discs were placed in an aluminum pan and placed in a Batch oven set at 130° C. After 5 minutes, the samples were removed and the apparent thermal conductivity was measured following the methods described above. Results are reported in Table 2.

In Table 2, Comparative Examples were formulated to have the same composition as the related multilayer, except these were prepared as a homogeneous sample. These comparatives represent the current state of the art and show that for a comparable formulation, samples that are not capable of inducing interfacial delamination have a much smaller thermal conductivity change upon expansion. Importantly, for the multilayer samples prepared at low expansions (and thus no shear delamination), the thermal conductivity ratio is comparable to the relevant comparative examples (i.e. EX-1 and EX-2 compared with CE-1 and CE-2, respectively). In contrast, samples that result in significant delamination after expansion (i.e. EX-4 and EX-5) exhibit a drastically different thermal conductivity ratio compared with the comparatives (CE-4 and CE-5).

TABLE 2

| | Apparent Thermal | Apparent Thermal | | |
|---|---|---|---|---|
| Example/ | Conductivity | Conductivity | Apparent Thermal | Shear |
| Comparative | as-cast, | after Expansion, | Conductivity | Delamination by |
| Example | W · m⁻¹K⁻¹ | W · m⁻¹K⁻¹ | Ratio | Visual Inspection |
| EX-1 | 1.18 | 0.992 | 0.84 | No |
| EX-2 | 1.08 | 0.660 | 0.61 | No |
| EX-3 | 1.09 | 0.362 | 0.33 | Yes (Partial) |
| EX-4 | 1.07 | 0.115 | 0.11 | Yes (Significant) |
| EX-5 | 1.10 | 0.114 | 0.10 | Yes (Significant) |
| CE-1 | 1.64 | 1.32 | 0.80 | N/A |
| CE-2 | 1.57 | 1.16 | 0.74 | N/A |
| CE-3 | 1.68 | 1.07 | 0.64 | N/A |
| CE-4 | 1.62 | 1.03 | 0.64 | N/A |
| CE-5 | 1.54 | 0.95 | 0.61 | N/A |

The preceding description, given in order to enable one of ordinary skill in the art to practice the claimed disclosure, is not to be construed as limiting the scope of the disclosure, which is defined by the claims and all equivalents thereto.

1. A thermal management assembly comprising:
a first electrochemical cell;
a heat sink; and
a thermal pathway comprising a first thermally interruptible interface interposed between the first electrochemical cell and the heat sink,
wherein the thermal pathway has a thermal conductance between the first electrochemical cell and the heat sink,
wherein the thermal pathway comprises a first expandable material comprising at least 10 vol % of first intumescent particles,
wherein the first expandable material intimately contacts a non-expandable, thermally conductive material at the first thermally interruptible interface, and
wherein, if heated to at least a first onset temperature, the first expandable material expands and causes at least partial shear delamination at the first thermally interruptible interface, thereby reducing the thermal conductance of the thermal pathway.

2. The thermal management assembly of claim 1, wherein the thermal pathway further comprises a second thermally interruptible interface interposed between the first electrochemical cell and the heat sink, wherein the first expandable material intimately contacts both of the first and second thermally interruptible interfaces, and wherein, if heated to at least the first onset temperature, the first expandable material expands and causes at least partial shear delamination at the second thermally interruptible interface, thereby reducing the thermal conductance of the thermal pathway.

3. The thermal management assembly of claim 1, wherein the first expandable material has the form of a first thin layer.

4. The thermal management assembly of claim 1, wherein the thermal pathway further comprises a first thermal conductor material in intimate contact with the first expandable material at the first thermally interruptible interface.

5. The thermal management assembly of claim 4, wherein the first thermal conductor material has the form of a second thin layer.

6. The thermal management assembly of claim 1, wherein the heat sink comprises a second electrochemical cell.

7. The thermal management assembly of claim 1, wherein at least one of the expandable material or the thermal conductor material at least partially conforms to at least one of a surface of the first electrochemical cell or a surface of the heat sink.

8. The thermal management assembly of claim 1, wherein the first expandable material comprises the first intumescent particles dispersed in a first organic binder.

9. The thermal management assembly of claim 4, wherein the thermal pathway further comprises a second expandable material interposed between the first thermal conductor material and the heat sink, wherein the second expandable material and the first thermal conductor material contact each other at a second thermally interruptible interface, wherein if heated to at least a second onset temperature the second expandable material expands sufficiently to at least partially disrupt the thermal pathway by causing shear delamination at the second thermally interruptible interface, thereby reducing the thermal conductance of the thermal pathway.

10. The thermal management assembly of claim 9, wherein the first and second onset temperatures are the same.

11. The thermal management assembly of claim 4, wherein the thermal pathway further comprises a second thermal conductor material interposed between the first expandable material and the heat sink, wherein the second thermal conductor material and the first expandable material contact each other at a second thermally interruptible interface, wherein if heated to at least a second onset temperature the first expandable material expands sufficiently to at least partially disrupt the thermal pathway by causing shear delamination at the second thermally interruptible interface, thereby reducing the thermal conductance of the thermal pathway.

12. The thermal management assembly of claim 1, wherein the thermal conductor material comprises a second intumescent particles dispersed in a second organic binder.

13. The thermal management assembly of claim 1, wherein thermal conductance between the first electrochemical cell and the heat sink is reduced by at least 50 percent at or above the first onset temperature.

14. The thermal management assembly of claim 1, wherein thermal conductance between the first electrochemical cell and the heat sink is reduced by at least 75 percent at or above the first onset temperature

15. The thermal management assembly of claim 1, wherein thermal conductance between the first electrochemical cell and the heat sink is reduced by at least 90 percent at or above the first onset temperature.

16. The thermal management assembly of claim 1, wherein total volume of the first and thermal conductor layers increases less than 50 percent at or above the first onset temperature.

17. The thermal management assembly of claim 1, wherein total volume of the first and thermal conductor layers increases less than 25 percent at or above the first onset temperature.

18. The thermal management assembly of claim 1, wherein total volume of the first and thermal conductor materials increases less than 10 percent at or above the first onset temperature.

19. A composite thermal management article comprising:
a first layer comprising at least 10 vol % of intumescent particles;
a second layer comprising a non-expandable, thermally conductive material, wherein the first and second layers intimately contact each other at a thermally interruptible interface, and wherein, if heated to at least a first onset temperature, the first layer expands to and causes at least partial shear delamination from the second layer at the thermally interruptible interface.

20. The composite thermal management article of claim 19, further comprising an adhesive layer disposed on the second layer opposite the first layer.

21-24. (canceled)
